(19) United States
(12) Patent Application Publication
(10) Pub. No.: US 2013/0022949 A1
(43) Pub. Date: Jan. 24, 2013

(54) Method of Teaching Confidence Trick by Means of Motivational Education Training to Prevent Problems

(71) Applicant: Taydama Saykon Jackson, Sacramento, CA (US)

(72) Inventor: Taydama Saykon Jackson, Sacramento, CA (US)

(21) Appl. No.: 13/627,316

(22) Filed: Sep. 26, 2012

Related U.S. Application Data
(63) Continuation-in-part of application No. 13/280,147, filed on Oct. 24, 2011.
Application No. 13/280,147 is a continuation-in-part of application No. 12/903,670, filed on Oct. 13, 2010.
(60) Provisional application No. 61/294,268, filed on Jan. 12, 2010.

(51) Int. Cl. G09B 19/00

(52) U.S. Cl. 434/236

(57) ABSTRACT

A method of teaching the confidence trick by means of motivational education training to prevent problems includes trainees. The trainees are educated by mentors of a motivational and educational learning and training academy. The mentors train the trainees to control their mind and to write an automatic writing statement. The automatic writing statement is written by implementing the automatic writing method. The trainees are also train to create an exact copy, where the exact copy includes a random question, the automatic writing statement, and a correct answer. Each of the trainees has a global warming guide and a criminal history book. The global warming guide includes a plurality of automatic writing statements, and the criminal history book includes a plurality of exact copies. The trainees are also able to obtain a degree program by submitting a predetermined number of the automatic writing statement and exact copy.

The current application is a continuation-in-part of, and claims a priority to application Ser. No. 13/280,147 filed on Oct. 24, 2011, which was a continuation-in-part that claimed a priority to application Ser. No. 12/903,670 filed on Oct. 13, 2010, which claimed the priority to application 61/294,268 filed on Jan. 12, 2010.

### FIELD OF THE INVENTION

The present invention relates generally to a motivational education training program for the prevention of problems. Specifically, the present invention is a method of teaching confidence trick while providing professional training in various career fields in an effort to reduce hostile work environments and increase accident awareness.

### BACKGROUND OF THE INVENTION

Many people easily get angry on job site, at school, and at home for many different reasons. Many people are frustrated at someone or about an incident because they have gotten defraud for money or other related services when they seek help, whether it's for weight loss, financial freedom, or anything else that requires them only to provide the answer. People who are confused about many things in life are easily agitated which often leads to violence at the work place, on school grounds, and at home. It is therefore an object of the present invention to provide answers through automatic writing which help to diffuse the confusion in people's life as it can provide the correct answers that one can only receive from within. With more people practicing self-improvement from the present invention, they are able to relieve tension at work, at school, and home. Through the present invention, people are able to see how threatening their language is by studying it and correcting their own unhealthy habits. People also learn about the confidence trick and many other subjects through the present invention so that they can be well prepared for any kind of problems or incidents.

### BRIEF DESCRIPTION OF THE DRAWINGS

FIG. 1 is a simplified flow chart illustrating the overall process of the present invention.

FIG. 2 is a simplified flow chart illustrating the process of creating an automatic writing statement of the present invention.

FIG. 3 is a simplified flow chart illustrating the importance of clerical errors of the present invention.

FIG. 4 is a simplified flow chart illustrating the process of creating an exact copy of the present invention.

FIG. 5 is a simplified flow chart illustrating a degree program of the present invention.

### DETAIL DESCRIPTIONS OF THE INVENTION

All illustrations of the drawings are for the purpose of describing selected versions of the present invention and are not intended to limit the scope of the present invention.

The present invention teaches trainees about the confidence trick through a motivational and educational learning and training academy (MELTA). The present invention can be implemented through the internet or classroom environments. Each of the trainees learns about the confidence trick and other social problems from the automatic writing method so that each of the trainees is well prepared to face upcoming challenges. The trainees, who study in the MELTA, must take an oath not to participate in violent crimes on school grounds or at work in order to help eliminate accidental deaths.

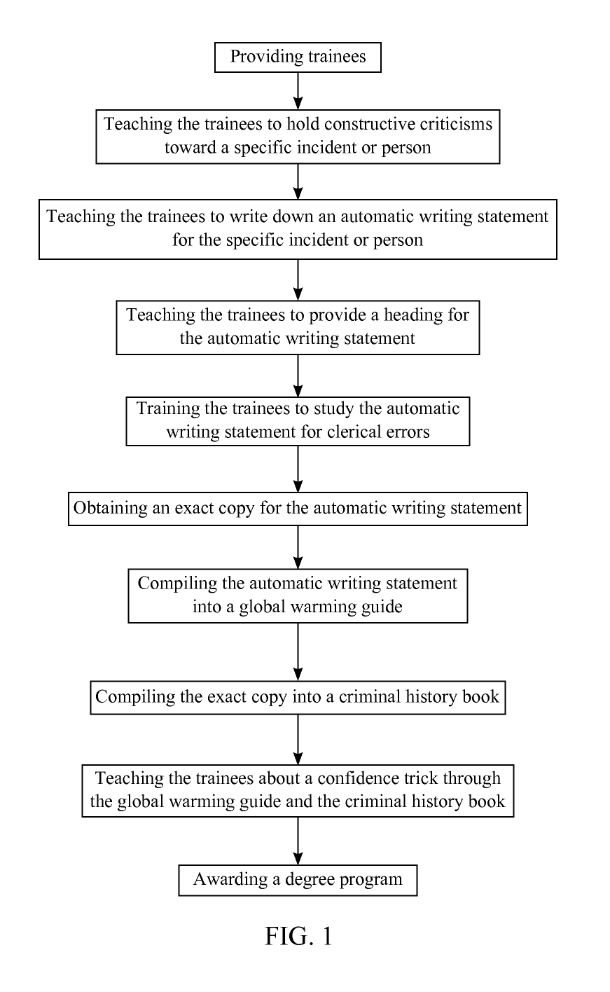

In reference to FIG. 1, mentors of the MELTA teach each of the trainees how not to express constructive criticisms toward a specific incident or person. Since every individual is uniquely different from another individual, most of the time people have disagreements where people tend to criticizes each other. Most often, this result into many problems and creates unnecessary circumstances. Traditional school system educates children with many different subjects, but the traditional school system never teaches children how to control their mind. The present invention teaches each of the trainees how to hold back the constructive criticisms. Once the trainees are able to control their own mind, the trainees can easily hold back the constructive criticisms. The trainees also learn the importance of controlling their actions civil through treating every individual with great respect. The trainees also learn that for every decision made, there are consequences, some are good and some are bad. For example, the present invention focuses on encouraging the trainees to express their emotions by writing, which help the trainees who harbor secrets of being bullied and teased to express themselves positively on paper. Then the trainees who participated able to help prevent the loss of not only their own life but the lives of others by removing fear, anger, and guilt of their predator's actions from their conscience. Due to the held back constructive criticisms and controlling their actions, unwanted emotions can be created within the trainees. As a solution, the present invention teaches the trainees to write down their emotions.

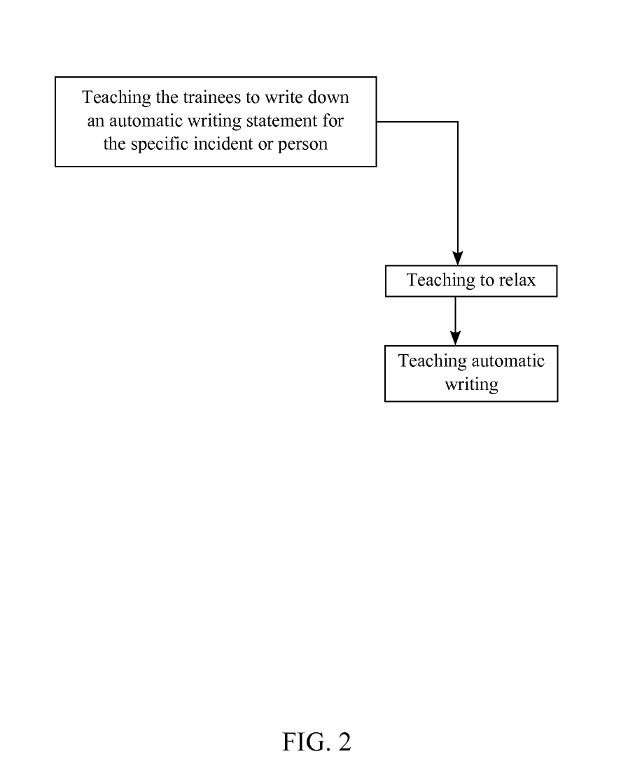

In reference to FIG. 2, the mentors of the MELTA teach the trainees to write down their thoughts into an automatic writing statement where the automatic writing statement directly correlates with the specific incident or person. The automatic writing statement is completed by the trainees with the implementation of the automatic writing method. The mentors teach the trainees about the automatic writing method so that the trainees are well knowledgeable and can achieve any desired goals. When the trainees are well educated with the automatic writing method, the trainees are never aware of what they are writing. The automatic writing method happens either through a person's subconscious or by external spirits that work through the person. In the automatic writing method, the person is in a state of trance, not knowing what they are writing. The automatic writing method is a way of connecting to the person's inner self to provide answers to questions about the person's life that they wonder about. The automatic writing method is a self-cleanser because it allows one to release all of the negative energy inside of their body through writing. The mentors teach the trainees to obtain the automatic writing statement by meditating and allowing the trainees' subconscious to provide answers without their knowledge or with their knowledge.

The mentors also teach the trainees to be relaxed before writing down the automatic writing statement. Due to the fact the trainees are mainly communicated with the mentors with the automatic writing statements, the trainees are able to write well thought out and detail oriented automatic writing statements. The automatic writing method helps the trainees to become more aware of their accidents through allowing them to translate the message through the automatic writing method. This training method helps the trainees to learn how easy it is to make mistakes and places them on guard to watch their own mistakes. Since the trainees constantly write the automatic writing statements, the automatic writing statements allow the trainees to improve the note taking techniques at school and work. As the trainees become more aware of their mistakes, they become more aware to other details such as their lack of attention to detail in the classroom, on the job, and on the roads. As a result, each of the trainees is able to successfully complete their school with honors, and the trainees are able to efficiently and correctly conduct job requirements. Moreover, each of the trainees is able concentrate on driving and walking activities, creating safer roads.

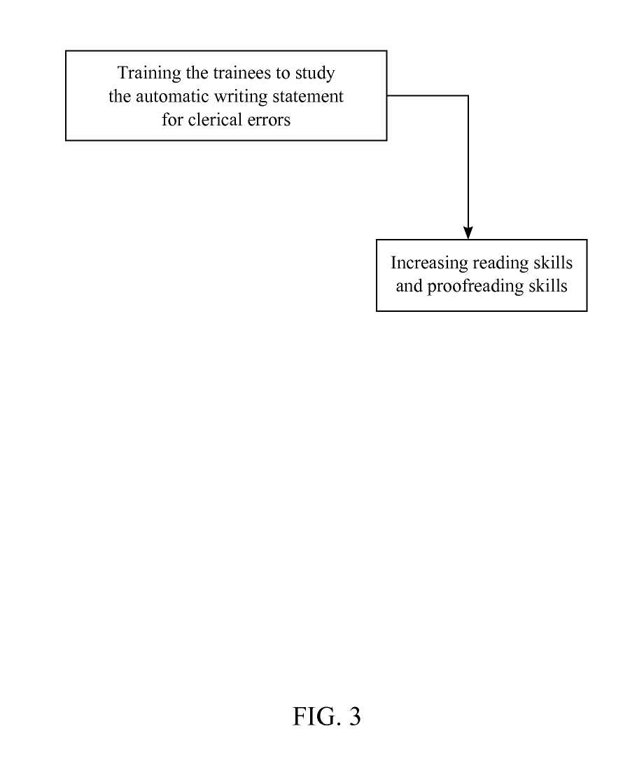

In reference to FIG. 1 and FIG. 3, then the mentors teach the trainees how to provide a heading for the automatic writing statement. The heading comprises information that helps each of the trainees to remember the specific incident or person. Since the number of time that the trainees become temper or upset within a day is unknown, the heading allows easy recognition to each of the automatic writing statements later on. Once the trainees complete the automatic writing statement with the heading, the trainees are supposed to study the automatic writing statement for clerical errors. The clerical errors help the trainees to improve their reading skills and proofreading skills The mentors of the present invention teach the trainees how to properly identify the clerical errors. Over time when the trainees are ready to learn on their own, the trainees are encouraged to re-read the automatic writing statements, where the automatic writing statements bring clarity into each of the trainees' lives about unanswered questions or concerns they may have regarding their lifestyle.

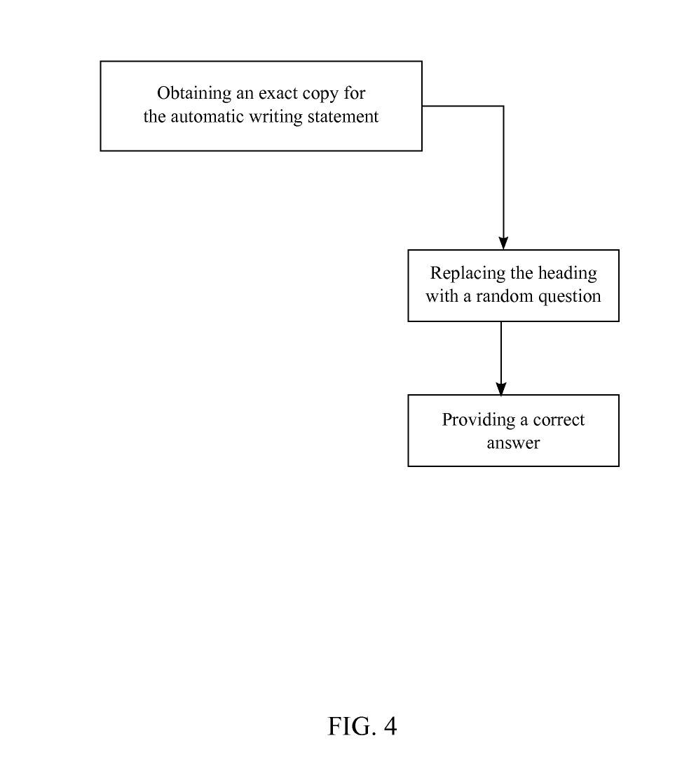

In reference to FIG. 4, once the clerical errors are identified, the trainees make an exact copy of the automatic writing statement. The trainees then alter the automatic writing statement by replacing the heading with a random question and provide a correct answer for the random question in order to create the exact copy. The mentors teach the trainees how to fully complete this process. The random question is placed on the top of the exact copy and the correct answer is placed on the bottom of the exact copy, where the automatic writing statement without the heading is positioned in between the random question and the correct answer. Then the MELTA obtains the exact copy and the automatic writing statement with the heading from each of the trainees.

The exact copy teaches the trainees how to avoid the confidence trick. No matter how well mannered the person is by nature, the random question, the correct answer, and the automatic writing statement on the exact copy allow the trainees to identify how someone would have use the confidence trick if the trainees verbally voice their opinions. Criminals usually hide their true intension so that they can't be caught. The exact copy teaches the trainees see truth behind every situation so that the trainees would not fall for the confidence trick used by the criminals. Since the random question and the correct answer are completely irrelevant with reference to the automatic writing statement, the exact copy illustrates how easy it is to hide information from people in order to profit from them. When the trainees are well educated about the confidence trick, the trainees can easily identify criminals who use the confidence trick to cheat from other people. When the criminals realize that the people are well aware of the confidence trick and there is a higher chance of getting caught, the criminals get more hesitant to commit crimes, resulting decrease in the number of crimes.

The mentors teach the trainees to please themselves before they please other people. Because if the trainees are not satisfied, they can't make other people satisfy. Sometimes the trainees would have to hide their true feeling in order to speak with manners so that the mentors educate the trainees how not to speak at all in those situations. In order to teach the trainees real life situations, people who have overcome the battle of struggles, such as addiction, molestation, or depression, the mentors share their stories with the trainees as well. In this case, motivational speakers are important to help influence the trainees in the right way. By speaking openly about the battle of struggles, the trainees can learn more about those struggles and be able to recognize signs of the battle of struggles in real life situations. Also, by hearing these real life stories, the trainees can recognize and understand the sequential order that is true for all events; essentially the trainees are able to understand how a series of events can lead into the battle of struggles.

The trainees are also encouraged to prepare further altered an audio clip of the exact copy by creating a random work environment and inputting the random question and the correct answer in order to help them to learn about how to eliminate hostile work environments. For example, the audio clip begins with a mentor's voice asking the random question which gives the trainees the feeling of being in school. Then the automatic writing statement is heard which gives the trainees the feeling of someone disrupting the class by blurting out random conversation or statement. Then the correct answer to the random question is heard which gives the trainees the feeling that at least one person is paying attention. Then the mentor responds, letting the trainees who provide the correct answer that they got the right answer. This is an example of a mentor who is not paying attention to the class and allowed a trainee to disrupt classroom.

Through the MELTA, the trainees are able to be creative and study different scenarios of hostile working environments. For example, if a trainee has experienced child molestation incidents or school shooting incidents, the trainee's studies focus more on those areas so that he or she can reduce hostile work environments. This training process helps to stimulate the trainees' creative skills, which helps to build confidence for the trainees to actively participate in school and help the trainees to be more of an asset on their regular jobs.

In reference to FIG. 1, the submitted automatic writing statement with the heading and exact copy are respectively compiled into a global warming guide and a criminal history book. The global warming guide comprises a plurality of automatic writing statements with the headings, and the criminal history book comprises a plurality of exact copies where each of plurality of exact copy includes the automatic writing statement, the random question, and the correct answer. The MELTA educates each of the trainees with the global warming guide and the criminal history book. Each of the trainees creates their own set of books, which becomes their curriculum to open up their own self-improving practice. In order to obtain credit through the MELTA, each of the trainees must submit the automatic writing statement with the heading and the exact copy. Depending on a predetermined number of the submitted automatic writing statement with the heading and exact copy from each of the trainees, each of the trainees is able to obtain a degree program from the MELTA.

The automatic writing statement with the heading and the exact copy that contain content glorify sexually explicit acts, pornography, glorifies rape and or incest, glorifies drug use and/or alcohol abuse, glorifies violence, glorifies murder, and glorifies drive by shootings are removed from the global warming guide and the criminal history book and do not count toward the curriculum. However, the automatic writing statement with the heading and the exact copy that contain content expressing pain, sadness, and the negativity of underage sex, unprotected sex, rape, incest, drug use, alcohol abuse, violence, murder, and drive-by shootings are acceptable.

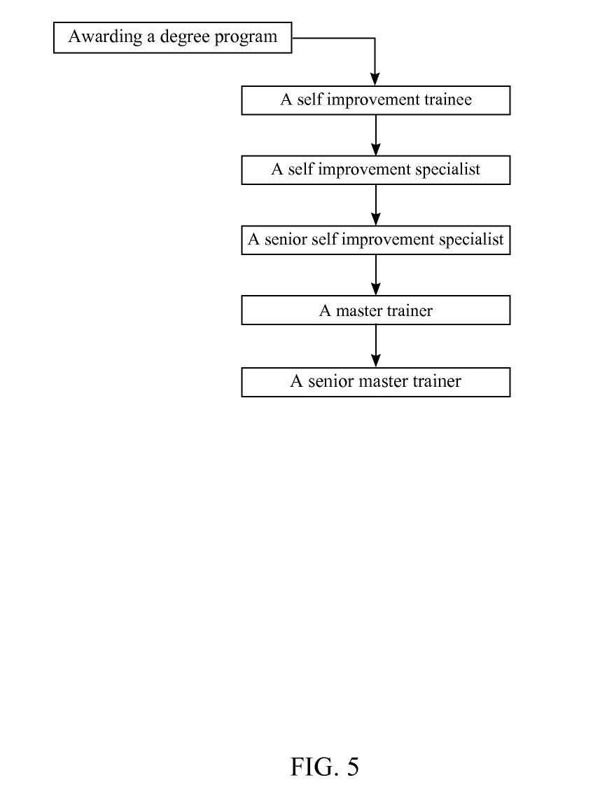

In reference to FIG. 5, the degree program includes five different levels, differentiated by the predetermined number of the submitted automatic writing statement with the heading and exact copy, to determine the level of degree that is obtained from the MELTA. In the preferred embodiment of the present invention includes the following five different levels. At the first level, each of the trainees is required to submit up to 100 the automatic writing statement with the heading and the exact copy and, each of the trainees is known as a self improvement trainee. The self improvement trainee has no equivalent traditional degree. At the second level, each of the trainees is required to submit up to 250 the automatic writing statement with the heading and the exact copy and, each of the trainees is known as a self improvement specialist. The self improvement specialist is equivalent to a traditional associate degree. At the third level, each of the trainees is required to submit up to 350 the automatic writing statement with the heading and the exact copy and, each of the trainees is known as a senior improvement specialist. The senior improvement specialist is equivalent to a traditional bachelor degree. At the fourth level, each of the trainees is required to submit up to 500 the automatic writing statement with the heading and the exact copy, and each of the trainees is known as a master trainer. The master trainer is equivalent to a traditional master degree. At the fifth level, each of the trainees is required to submit more than 501 the automatic writing statement with the heading and the exact copy and, each of the trainees is known as a senior master trainer. The senior master trainer is equivalent to a traditional doctor degree.

The trainees can continue their higher learning through the present invention. Once the trainees have obtained the senior improvement specialists, the master trainers, or the senior master trainers, the trainees are then able to open their own self-improvement motivator. Then the trainees are able to charge their clients to teach them how to find answers to their life using the automatic writing method. Additionally, the senior improvement specialists, the master trainers, and the senior master trainers from the MELTA are handpicked and trained by their mentors when the mentors believe the trainees are able to successfully perform certain tasks. The senior improvement specialists, the master trainers, and the senior master trainers from the MELTA may able to legally practice in their chosen professions, hold the title of their chosen fields, without the necessity of a traditional degree. This alternative method of learning can eliminate the necessity of the traditional college degree. In other words, the MELTA is considered as a professional school, allowing the trainees to skip college if they chose to do so. However, many participants are still required to pass any required tests to be licensed by the perspective state board. For example, if a trainee's goal is to become a lawyer, he or she would still need to pass the bar exam.

The present invention enables trainees to advance into multiple professional fields. Once the trainees master a particular field, the trainees are eligible for job training in another field. The trainees can not only obtain multiple certificates, but also gain knowledge in various fields of study. Since the trainees from the MELTA are highly gifted, the trainees could use their intellect to successfully prevent various crimes. As a result, the trainees create opportunities to utilize their knowledge in various areas that can only benefit communities instead of creating harm.

The trainees can start the degree programs with the MELTA before the trainees graduate from high school, but the MELTA supports the No Child Left Behind Act. Therefore, it is mandatory that the trainees complete high school in order for the degree program at the MELTA to remain active. The MELTA require report cards from each of the trainees on each year to verify their status at their respective high school. If any trainee drops out of high school before he or she graduates from high school, any degree achieved at the MELTA becomes null and void. The MELTA maintains a public listing of all valid degrees so that the public can view the public listing at all times.

Although the invention has been explained in relation to its preferred embodiment, it is to be understood that many other possible modifications and variations can be made without departing from the spirit and scope of the invention as hereinafter claimed.

What is claimed is:

1. A method of teaching the confidence trick by means of motivational education training to prevent problems comprises the steps of:
providing trainees;
teaching the trainees to hold constructive criticisms, if the trainees desires to express the constructive criticisms towards a specific incident or person;
teaching the trainees to write down an automatic writing statement with reference to the specific incident or person;
teaching the trainees to provide a heading for the automatic writing statement;
training the trainees to study the automatic writing statement for clerical errors;
obtaining an exact copy of the automatic writing statement from each of the trainees, wherein the exact copy is created from the automatic writing statement;
compiling the automatic writing statement with the heading into a global warming guide, wherein the global warming guide comprises a plurality of automatic writing statements with headings;
compiling the exact copy into a criminal history book, wherein the criminal history book comprises a plurality of exact copies from the plurality of automatic writing statements;
teaching the trainees about a confidence trick through the global warming guide and the criminal history book, wherein hostile work environments are reduced and accident awareness is increased; and
awarding a degree program to trainees, wherein the degree program includes a self improvement trainee, a self improvement specialist, a senior self improvement specialist, a master trainer, and a senior master trainer.

2. The method of teaching the confidence trick by means of motivational education training to prevent problems as claimed in claim 1 comprises,
encouraging the trainees to relax before write down the automatic writing statement; and
teaching the trainees to write down the automatic writing statement with the automatic writing method.

3. The method of teaching the confidence trick by means of motivational education training to prevent problems as claimed in claim 1 comprises,
wherein the heading comprises information that helps the trainees to remember the specific incident or person.

4. The method of teaching the confidence trick by means of motivational education training to prevent problems as claimed in claim 1 comprises,
increasing the reading skills and proofreading skills of the trainees from the clerical errors.

5. The method of teaching the confidence trick by means of motivational education training to prevent problems as claimed in claim 1 comprises,
teaching the trainees to replace the heading with a random question, in order to create the exact copy; and
teaching the trainees to provide a correct answer for the random question in the exact copy.

6. The method of teaching the confidence trick by means of motivational education training to prevent problems as claimed in claim 1 comprises,
assigning a first level as the self improvement trainee, wherein the self improvement trainee completes a predetermined number of the automatic writing statement with the heading and the exact copy.

7. The method of teaching the confidence trick by means of motivational education training to prevent problems as claimed in claim 1 comprises,
assigning a second level as the self improvement specialist, wherein the self improvement specialist completes a predetermined number of the automatic writing statement with the heading and the exact copy.

8. The method of teaching the confidence trick by means of motivational education training to prevent problems as claimed in claim 1 comprises,
assigning a third level as the senior self improvement specialist, wherein the senior self improvement specialist completes a predetermined number of the automatic writing statement with the heading and the exact copy.

9. The method of teaching the confidence trick by means of motivational education training to prevent problems as claimed in claim 1 comprises,
assigning a fourth level as the master trainer, wherein the master trainer completes a predetermined number of the automatic writing statement with the heading and the exact copy.

10. The method of teaching the confidence trick by means of motivational education training to prevent problems as claimed in claim 1 comprises,
assigning a fifth level as the senior master trainer, wherein the senior master trainer completes a predetermined number of the automatic writing statement and the exact copy.
